(19) United States
(12) Patent Application Publication
(10) Pub. No.: US 2016/0178903 A1
(43) Pub. Date: Jun. 23, 2016

(54) HEAD MOUNTED DISPLAY

(71) Applicant: Kabushiki Kaisha Toshiba, Tokyo (JP)

(72) Inventor: Yuji Nakajima, Nishitama Tokyo (JP)

(21) Appl. No.: 14/837,429

(22) Filed: Aug. 27, 2015

Related U.S. Application Data
(60) Provisional application No. 62/094,587, filed on Dec. 19, 2014.

(51) Int. Cl. G02B 27/01

(52) U.S. Cl. CPC G02B 27/017; G02B 2027/0178

(57) ABSTRACT

According to one embodiment, in a head mounted display, in a state in which a display unit is mounted on the user's head, the center of the user's head is positioned within a range formed by mutually connecting a display and a plurality of accommodation units which are adjacent to each other.

### CROSS-REFERENCE TO RELATED APPLICATIONS

This application claims the benefit of U.S. Provisional Application No. 62/094,587, filed Dec. 19, 2014, the entire contents of which are incorporated herein by reference.

### FIELD

Embodiments described herein relate generally to a head mounted display.

### BACKGROUND

A head mounted display which allows a user to visually recognize a virtual image while the head mounted display is worn on the user's head is known. In order to improve its portability, the head mounted display is required to be light and compact.

However, a weight balance at the time of wearing has not been considered. Accordingly, it is difficult to keep its mounting stability constant. In such a case, the weight balance is lost when the head is moved only a little. As a result, there is a fear that a virtual image goes out of sight or the virtual image becomes hard to see.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front perspective view of a head mounted display according to one embodiment;

FIG. 2 is an exploded perspective view showing a structure of the head mounted display of FIG. 1;

FIG. 3 is an exemplary right side view of the head mounted display of FIG. 1;

FIG. 4 is an exemplary left side view of the head mounted display of FIG. 1;

FIG. 5 is an exemplary plan view of the head mounted display of FIG. 1 as seen from a parietal region;

FIG. 6 is an exemplary perspective view of the head mounted display of FIG. 1 as seen from an occipital region;

FIG. 7 is an exemplary front perspective view of a head mounted display according to another embodiment;

FIG. 8 is an exemplary front perspective view of a head mounted display according to yet another embodiment; and

FIG. 9 is an exemplary right side view of a head mounted display according to yet another embodiment.

### DETAILED DESCRIPTION

Various embodiments will be described hereinafter with reference to the accompanying drawings. In general, according to one embodiment, in a head mounted display, in a state in which a display unit is mounted on a head of a user, the center of the user's head is positioned within a range formed by mutually connecting a display and a plurality of accommodation units which are adjacent to each other.

The head mounted display according to the embodiment will now be described referring to the accompanying drawings.

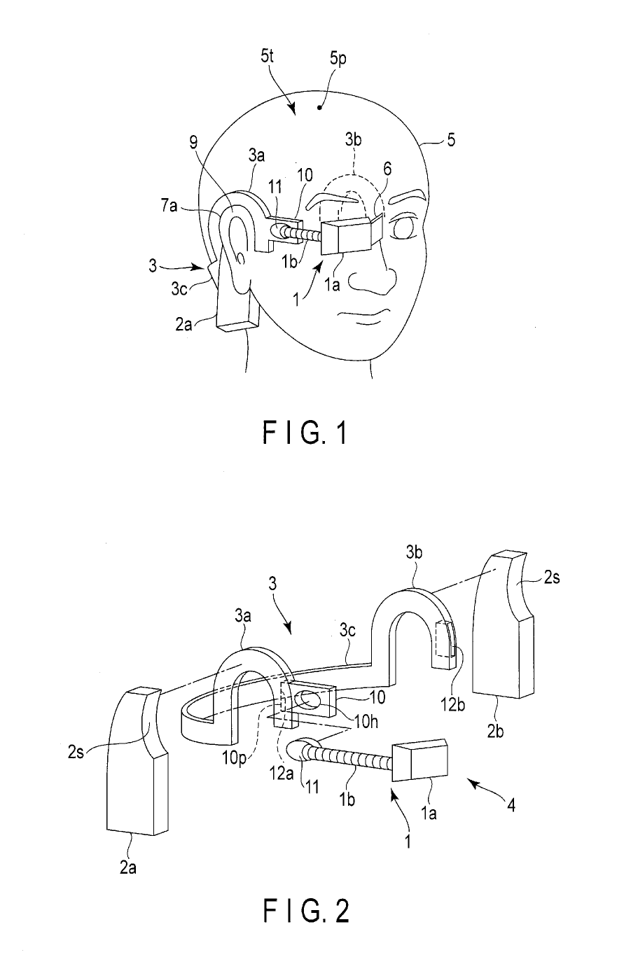

As shown in FIGS. 1 and 2, the head mounted display according to the present embodiment comprises a display unit 4 including a display 1, a plurality of accommodation units 2a and 2b, and a mounting mechanism 3. The mounting mechanism 3 is configured such that the display 1 and the accommodation units 2a and 2b can be mounted on a head 5 of the user. By this structure, the display 1 and the accommodation units 2a and 2b are arranged to be spaced apart from each other around the periphery of the head 5 of the user in a state in which the display unit 4 is mounted on the user's head 5.

The display 1 comprises a display main body 1a, and an arm 1b which supports the display main body 1a.

In the display main body 1a, a liquid crystal display, a lens, and a half mirror 6, for example, are provided. In this case, image information displayed on the liquid crystal display is projected on the half mirror 6 via the lens. The half mirror 6 reflects part of the projected light. In this way, the user is allowed to visually recognize a virtual image via the half mirror 6

The arm 1b has the function of extending, contracting, or bending itself. The display main body la is arranged on a distal end of the arm 1b. A proximal end of the arm 1b is detachably arranged on a base 10 of the mounting mechanism 3 which will be described later.

By the above structure, the attitude or position of the display main body 1a (the half mirror 6) can be adjusted freely within three-dimensional space. For example, in a state in which the display unit 4 is mounted on the head 5, by deforming the arm 1b, the display main body 1a (the half mirror 6) can be adjusted to be brought into an attitude or position in which the user can easily see the virtual image.

In the accommodation units 2a and 2b, components for operating the display 1 are accommodated. As the components, for example, an electronic circuit for operating the display 1, and a power source for supplying power to the electronic circuit and the display 1 are assumed. In the accommodation units 2a and 2b, the electronic circuit is accommodated in the first accommodation unit 2a, and the power source is accommodated in the second accommodation unit 2b.

Further, the liquid crystal display of the display 1, the electronic circuit in the first accommodation unit 2a, and the power source in the second accommodation unit 2b are electrically connected to each other via connecting components such as a cable and a flexible substrate. The connecting components are included in the components for operating the display 1. In the drawings, the connecting components are omitted.

As shown in FIGS. 1 to 6, the mounting mechanism 3 comprises a pair of frames 3a and 3b, and a band 3c which couples the pair of frames 3a and 3b together.

The pair of frames 3a and 3b consists of the first frame 3a which can be attached to a right ear 7a of the user, and the second frame 3b which can be attached to a left ear 7b of the user. In this structure, the above-described first accommodation unit 2a is mounted to the first frame 3a. Meanwhile, the above-described second accommodation unit 2b is mounted to the second frame 3b. As the way of securing the above, an existing method such as gluing or fixing by screws can be applied.

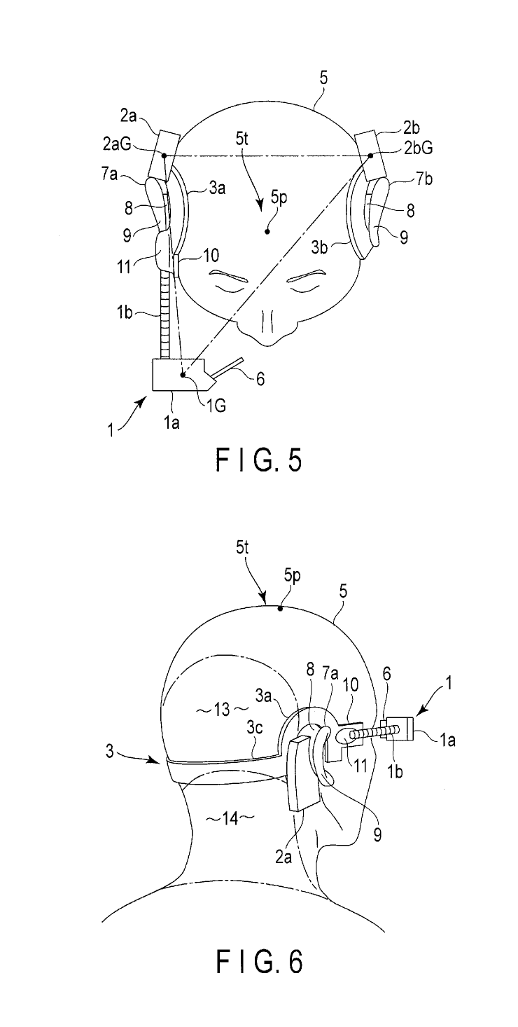

The first frame 3a has a shape of allowing itself to be hooked onto a root 8 (FIGS. 5 and 6) of the right ear 7a. The root 8 of the right ear 7a is the part where an auricular region 9 of the right ear 7a is connected to the head 5. The auricular region 9 is formed to be projected outward to the right from the head 5. The drawings show, as an example, the first frame 3a which is hollow and having an arc-shaped configuration along the contour of the root 8.

In this case, in a state in which the first frame 3a is hooked onto the root 8 of the right ear 7a, the weight of the first accommodation unit 2a acts on the first frame 3a. The first frame 3a is thereby positioned along the root 8 of the right ear 7a stably.

The second frame 3b has a shape of allowing itself to be hooked onto a root 8 (FIG. 5) of the left ear 7b. The root 8 of the left ear 7b is the part where an auricular region 9 of the left ear 7b is connected to the head 5. The auricular region 9 is formed to be projected outward to the left from the head 5. The drawings show, as an example, the second frame 3b which is hollow and having an arc-shaped configuration along the contour of the root 8.

In this case, in a state in which the second frame 3b is hooked onto the root 8 of the left ear 7b, the weight of the second accommodation unit 2b acts on the second frame 3b. The second frame 3b is thereby positioned along the root 8 of the left ear 7b stably.

It should be noted that the shapes of the roots 8 of the two ears 7a and 7b have different contours according to users. Accordingly, the shapes of the first and the second frames 3a and 3b should preferably set based on the average shape (contour) of the roots 8 measured for a plurality of users, for example.

Further, curved surfaces 2s (FIG. 2) along the contours of the roots 8 are formed on first and the second accommodation units 2a and 2b, respectively. Here, in a state in which the first and the second frames 3a and 3b are hooked onto the roots 8 of the two ears 7a and 7b, each of the curved surfaces 2s is positioned along the root 8. Accordingly, comfort is not impaired.

Also, the band 3c is connected to end portions of the first and the second frames 3a and 3b via an occipital region 13 of the user. The first and the second frames 3a and 3b are thereby coupled together via the band 3c.

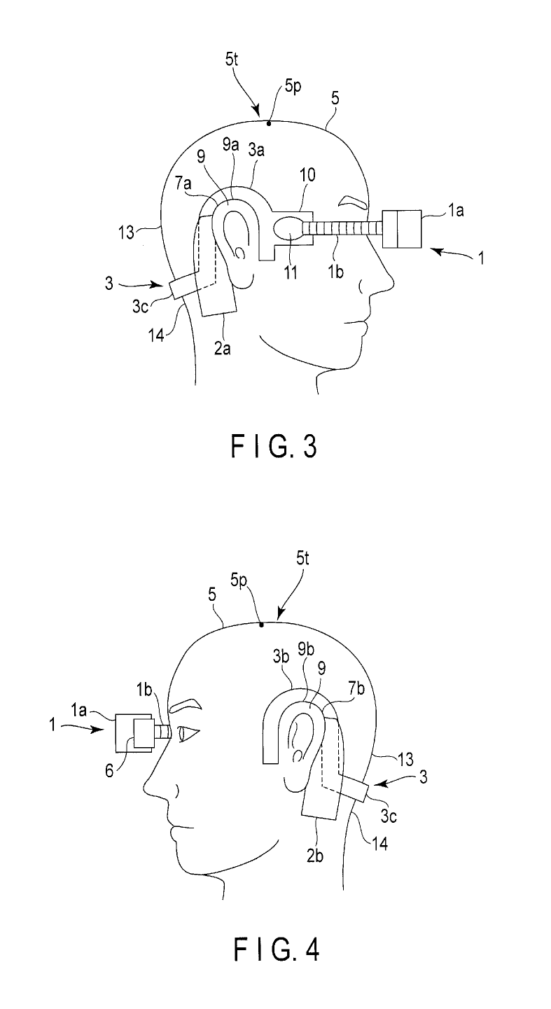

As the arrangement of the band 3c, the band 3c extends along an area which is most distant from a parietal region 5t in the occipital region 13 of the head 5 of the user (see FIGS. 3, 4, and 6). In other words, the band 3c extends along a boundary portion between the occipital region 13 and a posterior cervical region 14 of the user. Note that the posterior cervical region 14 is the portion for connecting between the head 5 and the torso, and is adjacent to the occipital region 13.

Here, by hooking the first and the second frames 3a and 3b onto the roots 8, in a state in which the display unit 4 is mounted on the head 5 of the user, the total weight of the first and the second accommodation units 2a and 2b balances the weight of the display 1 or is greater than the weight of the display 1 with the first and the second frames 3a and 3b serving as fulcrums. Note that the fulcrums mentioned above can be defined as portions where, for example, the first and the second frames 3a and 3b contact the roots 8, respectively.

In this structure, the band 3c is brought into a state of always contacting the occipital region 13 or the posterior cervical region 14. Accordingly, for example, it is possible to prevent the display unit 4 from being rotated or shifted in the direction of the occipital region 13 about the first and the second frames 3a and 3b as the fulcrums. As a result, the display unit 4 is always kept in a constant position.

Further, the mounting mechanism 3 is provided with the base 10. The proximal end of the arm 1b of the display 1 described above is detachably arranged on the base 10. For example, a mounting hole 10h (FIG. 2) is formed in the base 10. The proximal end of the arm 1b is provided with an attachment 11 which can be fitted into the mounting hole 10h.

In this case, by fitting the attachment 11 into the mounting hole 10h, the proximal end of the arm 1b can be firmly secured to the base 10. Conversely, by pulling out the attachment 11 from the mounting hole 10h, the proximal end of the arm 1b can be removed from the base 10 smoothly.

Further, the mounting mechanism 3 is configured to be adaptable to both cases of the user's visually recognizing the virtual image with the right eye and the user's visually recognizing the same with the left eye. In order to realize the aforementioned structure, the base 10 is configured to be detachably arranged on the first and the second frames 3a and 3b.

FIG. 2 shows as an example that the first frame 3a is provided with a right opening 12a. The right opening 12a is configured to allow an end portion 10p of the base 10 to be removably inserted therein. Also, the second frame 3b is provided with a left opening 12b. The left opening 12b is configured to allow the end portion 10p of the base 10 to be removably inserted therein.

In the above configuration, the attachment 11 is fitted into the mounting hole 10h of the base 10. Next, the end portion 10p of the base 10 is inserted into the right opening 12a of the first frame 3a. In this state, the display main body 1a (the half mirror 6) is positioned in front of the user's right eye. In this way, the user can visually recognize the virtual image with the right eye.

Further, the end portion 10p of the base 10 is drawn out from the right opening 12a of the first frame 3a. After removing the attachment 11 from the mounting hole 10h of the base 10, the attachment 11 is fitted into the mounting hole 10h from the opposite side. Next, the end portion 10p of the base 10 is inserted into the left opening 12b of the second frame 3b. In this state, the display main body 1a (the half mirror 6) is positioned in front of the user's left eye. In this way, the user can visually recognize the virtual image with the left eye.

In this case, in the first and the second frames 3a and 3b, the periphery of each of the right opening 12a and the left opening 12b should preferably be reinforced. As the way of reinforcement, for example, the periphery of each of the right opening 12a and the left opening 12b can be made thick, or can be made by a material having high rigidity.

In this way, the base 10 can be firmly secured to the first and the second frames 3a and 3b. Consequently, it is possible to prevent the base 10 from dropping out of the first and the second frames 3a and 3b.

Further, in the present embodiment, in a state in which the display unit 4 is mounted on the head 5 of the user, the display unit 4, the display 1, and the first and the second accommodation units 2a and 2b should preferably be structured as described below.

The center of gravity of the display unit 4 is positioned at a center 5p of the head 5 of the user or its surrounding. In other words, the center 5p of the head 5 of the user is positioned within a range formed by mutually connecting the display 1 and the first and the second accommodation units 2a and 2b which are adjacent along the periphery of the head 5 of the user.

Note that the center of gravity of the display unit 4 can be defined based on the gravity that acts on the whole of the display unit 4 including, for example, the display 1, the first and the second accommodation units 2a and 2b, and the mounting mechanism 3. Also, the center 5p of the head 5 can be defined as, for example, the uppermost portion of the parietal region 5t or the back-and-forth-and-right-and-left intermediate portion of the parietal region 5t.

From another perspective, the center 5p of the head 5 of the user is positioned within a range formed by mutually connecting the center of gravity 1G, 2aG, and 2bG of the corresponding display 1 and first and the second accommodation units 2a and 2b which are adjacent along the periphery of the head 5 of the user (see FIG. 5).

Note that the center of gravity 1G of the display 1 can be defined based on the gravity that acts on the whole of the display main body 1a including, for example, the liquid crystal display, the lens and the half mirror 6. The center of gravity 2aG of the first accommodation unit 2a can be defined based on the gravity that acts on the whole of the first accommodation unit 2a including, for example, the electronic circuit. The center of gravity 2bG of the second accommodation unit 2b can be defined based on the gravity that acts on the whole of the second accommodation unit 2b including, for example, the power source.

Further, in the head 5 of the user, the first and the second accommodation units 2a and 2b are arranged in regions between one of the pair of auricular regions 9 on both sides of the head 5 and the occipital region 13 of the head 5, and between the other auricular region 9 and the occipital region 13.

In this case, the first and the second accommodation units 2a and 2b are arranged in areas near the pair of auricular regions 9, which are on the side of the occipital region 13, separately. That is, the first accommodation unit 2a is arranged along a portion on the side of the occipital region 13 of the root 8 (FIGS. 5 and 6) of the right ear 7a. Meanwhile, the second accommodation unit 2b is arranged along a portion on the side of the occipital region 13 of the root 8 (FIG. 5) of the left ear 7b.

Further, the first and the second accommodation units 2a and 2b are arranged in ranges which do not exceed the pair of auricular regions 9 toward the parietal region 5t, respectively. That is, the first accommodation unit 2a is arranged in a range which does not exceed portion 9a that is most close to the parietal region 5t of the auricular region 9 (FIG. 3) of the right ear 7a. Meanwhile, the second accommodation unit 2b is arranged in the range which does not exceed portion 9b that is most close to the parietal region 5t of the auricular region 9 (FIG. 4) of the left ear 7b.

FIGS. 3 and 4 show a structure in which the whole of the first accommodation unit 2a and the whole of the second accommodation unit 2b are within a range of not exceeding the auricular regions 9 toward the parietal region 5t. However, alternatively, a structure in which the center of gravity of the first accommodation unit 2a and the center of gravity of the second accommodation unit 2b are within the range of not exceeding the auricular regions 9 toward the parietal region 5t, and a part of the first accommodation unit 2a and a part of the second accommodation unit 2b are at positions exceeding the auricular regions 9 may be adopted.

In this structure, of thicknesses of the first and the second accommodation units 2a and 2b, the thickness of the portion exceeding the auricular region 9 is less than the thickness of the other portions. Here, the thicknesses of the first and the second accommodation units 2a and 2b are defined along a direction which is orthogonal to a surface of the head 5 that the first and the second accommodation units 2 and 2b contact. Because of this structure, the user can wear a protective helmet 15 (FIG. 8) smoothly on the head 5, for example, without having the first and the second accommodation units 2a and 2b as an obstacle.

As described above, according to the present embodiment, the mounting stability of the display unit 4 with respect to the head 5 of the user can be kept constant. That is, in the display unit 4, structures which are relatively heavy are separated as several parts. The center 5p of the head 5 of the user is positioned within a range surrounded by the divided weighing objects (the display 1, the first accommodation unit 2a, and the second accommodation unit 2b). In this way, the weight of the display unit 4 can be balanced about the center 5p of the head 5. As a result, the display unit 4 mounted on the head 5 can always be kept in a constant position.

Further, by balancing the weight of the display unit 4 as descried above, it is possible to prevent the display unit 4 from rotating or shifting at the time of mounting. The display main body 1a of the display 1 can thereby be kept in an attitude or position in which the user can easily see the virtual image. At the same time, the wearing comfort of the display unit 4 can be kept constant.

Further, when taking weight balance, no new weighing object needs to be added. Portability can thereby be improved as a result of achieving lightness and downsizing of the display unit 4. Consequently, the display unit 4 which does not make the user feel tired even in a continuous long use can be realized.

Furthermore, by taking weight balance by the above-mentioned weighing objects (the display 1, the first accommodation unit 2a, and the second accommodation unit 2b), it becomes possible to widely expose a facial portion of the head 5, that is, to prevent an obstacle object from existing in front of the facial part of the head 5. Thus, it is possible to, for example, wipe one's whole face or wear safety goggles while the display unit 4 is mounted on the head 5.

Moreover, in a state in which the display unit 4 is mounted on the head 5, the range extending from the auricular regions 9 on both side of the head 5 toward the parietal region 5t can be made wide open, that is, the above range can be ensured to have no obstacle object. Thus, it becomes possible to, for example, wear ear protectors or wear the protective helmet 15 (FIG. 8) while the display unit 4 is mounted on the head 5.

In this case, the ear protectors or the protective helmet 15 can be made to contact the head 5 without having any gap therebetween. In other words, a contact area between the ear protectors or the protective helmet 15 and the head 5 can be increased. Because of this, the ear protectors or the protective helmet 15 is not shifted. As a result, the user's safety can be ensured.

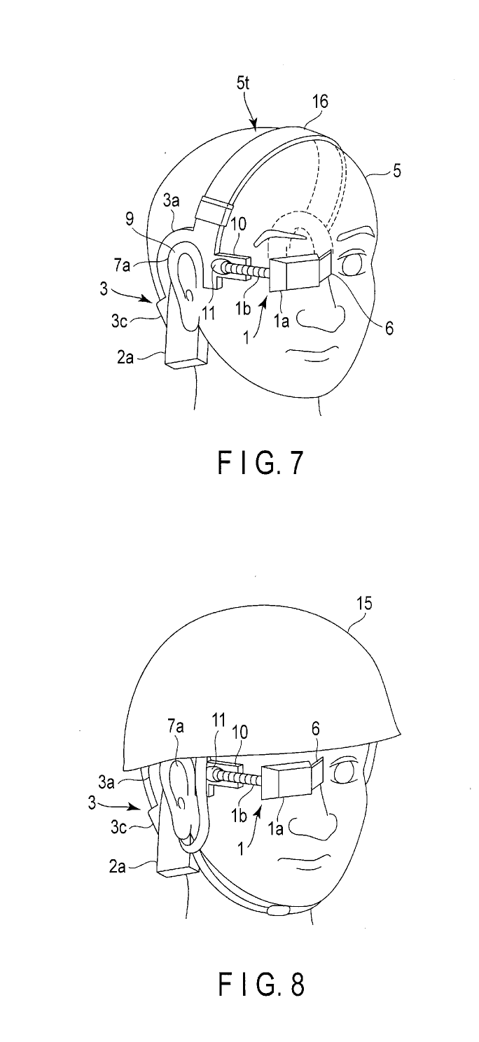

Here, as shown in FIG. 7, an auxiliary band 16 can be additionally provided in the display unit 4. The auxiliary band 16 is connected to the first and the second frames 3a and 3b via the parietal region 5t of the user. The length of the auxiliary band 16 can be adjusted in accordance with the size or shape of the head 5 of the user. As a connecting location of the auxiliary band 16, the auxiliary band 16 should preferably be connected at arc-shaped portions in the first and the second frames 3a and 3b, for example.

In that case, the display unit 4 can be mounted on the head 5 while the first and the second frames 3a and 3b are pulled up. Consequently, at the time of mounting, a load (for example, the weight of the first and the second accommodation units 2a and 2b) acting on the roots 8 of the two ears 7a and 7b of the user from the first and the second frames 3a and 3b can be reduced. As a result, the display unit 4 which does not make the user have a sense of discomfort even in a continuous long use can be realized.

Also, for example, a microphone, an earphone, a camera, a light, etc., may be additionally provided in the display unit 4.

Further, for example, in wearing the safety goggles, if a pair of temples which supports the goggles interferes with the arm 1b of the display 1, the arm 1bmay be inclined so as to avoid such interference.

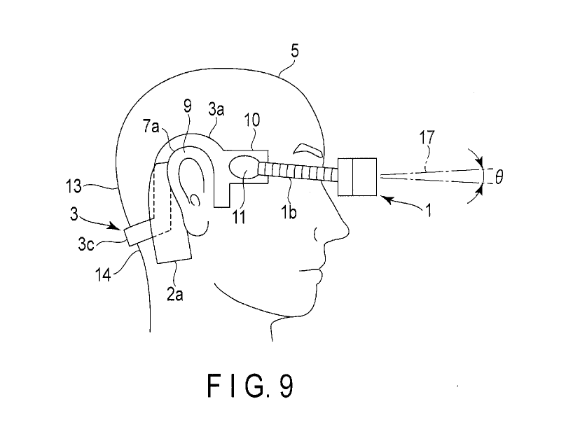

FIG. 9 shows the arm 1b which is inclined relative to a direction 17 of the pair of temples in a state in which goggles (not shown) are worn. The arm 1bis inclined with a falling gradient toward foreside of the eyes. Inclination angle θ can be set in accordance with the size or shape of the pair of temples.

Also, in the above-described embodiments, the components for operating the display 1 are classified into two groups and the classified components are accommodated in the first and the second accommodation units 2a and 2b. However, alternatively, the components may be classified into three or more groups and those components may be accommodated in three or more accommodation units.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A head mounted display comprising a display device comprising:
a display which allows a user to visually recognize a virtual image;
a plurality of accommodation units in which components for operating the display are accommodated; and
a mounting mechanism configured to mount the display and the plurality of accommodation units on user's head,
wherein in a state in which the display device is mounted on the user's head,
the display and the plurality of accommodation units are spaced apart from each other along a periphery of the user's head, and
a center of the user's head is positioned within a range formed by mutually connecting the display and the plurality of accommodation units which are adjacent along the periphery of the user's head.

2. The head mounted display of claim 1, wherein in the state in which the display device is mounted on the user's head, a center of gravity of the display device is positioned at the center of the user's head or its surrounding.

3. The head mounted display of claim 2, wherein the center of the user's head is positioned within a range formed by mutually connecting a center of gravity of each of the display and the plurality of accommodation units which are adjacent along the periphery of the user's head.

4. The head mounted display of claim 1, wherein
the display is arranged in an area in front of user's eye, and
in the user's head, the plurality of accommodation units are in regions between one of a pair of auricular regions and an occipital region of the head, and between the other one of the pair of auricular regions and the occipital region of the head, the pair of auricular regions being projected outwardly from both sides of the head.

5. The head mounted display of claim 4, wherein
the plurality of accommodation units comprises:
a first accommodation unit in which an electronic circuit for operating the display is accommodated; and
a second accommodation unit in which a power source for supplying power to the electronic circuit and the display is accommodated, and
the first and the second accommodation units are in areas near the pair of auricular regions, which are on the side of the occipital region 13, separately.

6. The head mounted display of claim 5, wherein the first and the second accommodation units are in a range which do not exceed the pair of auricular regions toward a parietal region, respectively.

7. The head mounted display of claim 6, wherein the mounting mechanism comprises:
a pair of frames configure to be hooked onto roots by which the pair of auricular regions is connected to the head; and
a band configured to couple the pair of frames together, and wherein
the first and the second accommodation units are separately mounted to the pair of frames, and
the band extends along an area which is farthest from the parietal region in the occipital region of the user's head.

8. The head mounted display of claim 7, wherein by hooking the pair of frames onto the roots, in a state in which the display device is mounted on the user's head, a total weight of the first and the second accommodation units balances a weight of the display or is greater than the weight of the display with the pair of frames serving as fulcrums.

9. The head mounted display of claim 8, wherein the display device is kept in a constant position as the band of the mounting mechanism contacts the occipital region or a posterior cervical region which connects between the head and a torso in a state in which the display device is mounted on the user's head.
